(19) United States
(12) Patent Application Publication
(10) Pub. No.: US 2019/0286282 A1
(43) Pub. Date: Sep. 19, 2019

(54) METHODS AND SYSTEMS FOR ADJUSTING A LAYOUT OF APPLICATIONS DISPLAYED ON A SCREEN

(71) Applicant: HONDA MOTOR CO., LTD., Tokyo (JP)

(72) Inventor: Evan Thomas SULLIVAN, Culver City, CA (US)

(21) Appl. No.: 15/921,232

(22) Filed: Mar. 14, 2018

(51) Int. Cl. G06F 3/0481; G06F 3/0484

(52) U.S. Cl. CPC G06F 3/0481; G06F 3/04842

(57) ABSTRACT

Methods and systems for adjusting a layout of applications presented to a user via a graphical user interface (“GUI”). The methods and systems may include reorienting a specific application provided on a GUI, based upon the location and orientation of additional applications displayed over a portion of the specific application, so as to be centered in a remaining portion of GUI.

### TECHNICAL FIELD

The present disclosure relates to methods and systems for adjusting a layout of applications presented to a user on a screen via a graphical user interface (“GUI”).

### BACKGROUND

When in operation, current vehicles run a number of hardware and software systems, applications, processes, and tasks, among other operations. In order to translate and convey meaningful information to a user, the vehicle must display large amounts of data and content in the form of controls, knobs, buttons, screens, etc. The more advanced the vehicle becomes, the more data needs to be displayed to the user. As vehicles move away from manual operations and analog information conveyance (e.g., driving and switches) due to the transition to digital systems, single device screens have become a popular means of displaying data and other content to a user. Although screens have become cheaper to produce and vehicles have implemented larger size screens in their designs, the data that needs to be displayed to the user has increased at an even faster pace. Typically, a screen toggles between data and other information/content to be displayed to user. For example, if a user wants to view the radio, the user selects the radio application to be displayed on the screen. If the user also wants to view the audio settings application, the user selects the audio settings feature to be displayed on the screen. In some instances, it may be beneficial to the user to concurrently view a plurality of applications. There is a need in the art, therefore, for methods and systems for adjusting a layout of the plurality of applications on the screen in order to maximize both the size of each of the specific applications and the data and other information that needs to be conveyed to the user.

### SUMMARY

The following presents a summary of one or more aspects of the disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the disclosure in a simplified form as a prelude to the more detailed description that is presented later.

In an example, a method is provided for adjusting a layout of a graphical user interface on a screen. The method includes displaying a first application on the screen oriented in the center of the GUI as a first layer. In addition, the method includes receiving via the GUI, a selection of a second application by the user; and updating the layout of the GUI to concurrently display the first application and the second application. Further, the second application is displayed as a second layer over a portion of the first layer, and the first application is reoriented on the first layer so as to be centered in a remaining portion of the first layer.

In another example, a system is provided that includes a memory and a processor coupled to the memory. In addition, the system displays a first application on a screen oriented in the center of a graphical user interface as a first layer. In addition, the system receives via the GUI, a selection of a second application by a user; and updates a layout of the GUI to concurrently display the first application and the second application. The second application is displayed as a second layer over a portion of the first layer, and the first application is reoriented on the first layer so as to be centered in a remaining portion of the first layer. In addition, the first and second applications are stored in the memory.

In a further example, a non-transitory computer-readable medium storing computer executable code is provided for displaying a first application on a screen oriented in the center of a graphical user interface as a first layer. In addition, the non-transitory computer-readable medium storing computer executable code is provided for receiving via the GUI, a selection of a second application by a user; and updating a layout of the GUI to concurrently display the first application and the second application. The second application is displayed as a second layer over a portion of the first layer, and the first application is reoriented on the first layer so as to be centered in a remaining portion of the first layer.

To the accomplishment of the foregoing and related ends, the one or more aspects of the disclosure comprise the features hereinafter fully described and particularly pointed out in the claims. The following description and the annexed drawings set forth in detail certain illustrative features of the one or more aspects. These features are indicative, however, of but a few of the various ways in which the principles of various aspects can be employed, and this description is intended to include all such aspects and their equivalents.

### BRIEF DESCRIPTION OF THE DRAWINGS

The novel features believed to be characteristic of aspects described herein are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 illustrates a schematic view of an example operating environment of a layout adjustment system according to one aspect of the disclosure;

FIG. 2 illustrates a flowchart illustrating an example method for adjusting a screen according to one aspect of the disclosure;

FIG. 3A illustrates an example of a portion of a layout adjustment system on a display according to one aspect of the disclosure;

FIG. 3B illustrates an example of a portion of a layout adjustment system on a display according to one aspect of the disclosure;

FIG. 3C illustrates an example of a portion of a layout adjustment system on a display according to one aspect of the disclosure;

FIG. 4 presents an example system diagram of various hardware components and other features according to one aspect of the disclosure; and

FIG. 5 is a block diagram of various example system components according to one aspect of the disclosure.

### DETAILED DESCRIPTION

The following includes definitions of selected terms employed herein. The definitions include various examples and/or forms of components that fall within the scope of a term and that can be used for implementation. The examples are not intended to be limiting.

The term “bus,” as used herein, can refer to an interconnected architecture that is operably connected to transfer data between computer components within a singular or multiple systems. The bus can be a memory bus, a memory controller, a peripheral bus, an external bus, a crossbar switch, and/or a local bus, among others. The bus can also be a vehicle bus that interconnects components inside a vehicle using protocols such as Controller Area network (CAN), Local Interconnect Network (LIN), among others.

The term “electronic vehicle,” as used herein, can refer to any moving vehicle that is capable of carrying one or more human occupants and is powered by an electronic battery and/or any form of energy that can be recharged at a charging station. The term “vehicle” can include, but is not limited to: cars, trucks, vans, minivans, SUVs, motorcycles, scooters, boats, personal watercraft, and aircraft.

The term “memory,” as used herein, can include volatile memory and/or nonvolatile memory. Non-volatile memory may include ROM (read only memory), PROM (programmable read only memory), EPROM (erasable PROM) and EEPROM (electrically erasable PROM). Volatile memory may include RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term “operable connection,” as used herein, can include a connection by which entities are “operably connected”, is one in which signals, physical communications, and/or logical communications can be sent and/or received. An operable connection can include a physical interface, a data interface and/or an electrical interface.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor may include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The term “vehicle system,” as used herein, can refer to an electronically controlled system on a vehicle operable to perform certain actions on components of the vehicle, which can provide an interface to allow operation by another system or graphical user interaction. The vehicle systems can include, but are not limited to, vehicle ignition systems, vehicle conditioning systems (e.g., systems that operate a windshield wiper motor, a windshield washer fluid motor or pump, a defroster motor, heating, ventilating, and air conditioning (HVAC) controls, etc.), vehicle audio systems, vehicle security systems, vehicle video systems, vehicle infotainment systems, vehicle telephone systems, and the like.

The term “vehicle applications” or “applications,” as used herein, can refer to any software run by the vehicle system, which can provide information or data to a user of the vehicle, or can receive information or data from a user of a vehicle. The vehicle applications may be displayed on the screen and can include, but are not limited to, navigation, radio, telephone, settings, electric charging, status information, cameras, web browsers, e-mail, games, utilities, and the like.

The term “graphical user interface,” “GUI,” or “user interface,” as used herein, can refer to a type of interface that allows users to interact with electronic devices, the vehicle system, the vehicle, vehicle applications or the like, through graphical icons, visual indicators such as secondary notation, text-based, type command labels, text navigation, and the like.

The term “screen,” “display screen,” or “display,” as used herein, can refer to a surface area upon which text, graphics and video are temporarily made to appear for human viewing. These may include, but are not limited to, eidophor, electroluminescent display (“ELD”), electronic paper, e-Ink, gyricon, light emitting diode display (“LED”), cathode ray tube (“CRT”), liquid-crystal display (“LCD”), plasma display panel (“PDP”), digital light processing (“DLP”), and the like.

The term “communications device,” as used herein, can refer to a device that facilitates intercommunication among vehicle systems, communication with the vehicle systems via one or more other systems or devices, etc. In an example, communication device can interface with other systems, such as a remote device, other computers, etc., via a wireless communication technology, such as a cellular technology, Bluetooth, etc. using a corresponding modem or transceiver.

The detailed description set forth below in connection with the appended drawings is intended as a description of various configurations and is not intended to represent the only configurations in which the concepts described herein can be practiced. The detailed description includes specific details for the purpose of providing a thorough understanding of various concepts. However, it will be apparent to those skilled in the art that these concepts can be practiced without these specific details. In some instances, well known structures and components are shown in block diagram form in order to avoid obscuring such concepts.

Several aspects of certain systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements can be implemented using electronic hardware, computer software, or any combination thereof. Whether such elements are implemented as hardware or software depends upon the particular application and design constraints imposed on the overall system.

By way of example, an element, or any portion of an element, or any combination of elements can be implemented with a “processing system” that includes one or more processors. One or more processors in the processing system can execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described can be implemented in hardware, software, firmware, or any combination thereof. If implemented in software, the functions can be stored on or encoded as one or more instructions or code on a computer-readable medium. Computer-readable media includes computer storage media. Storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

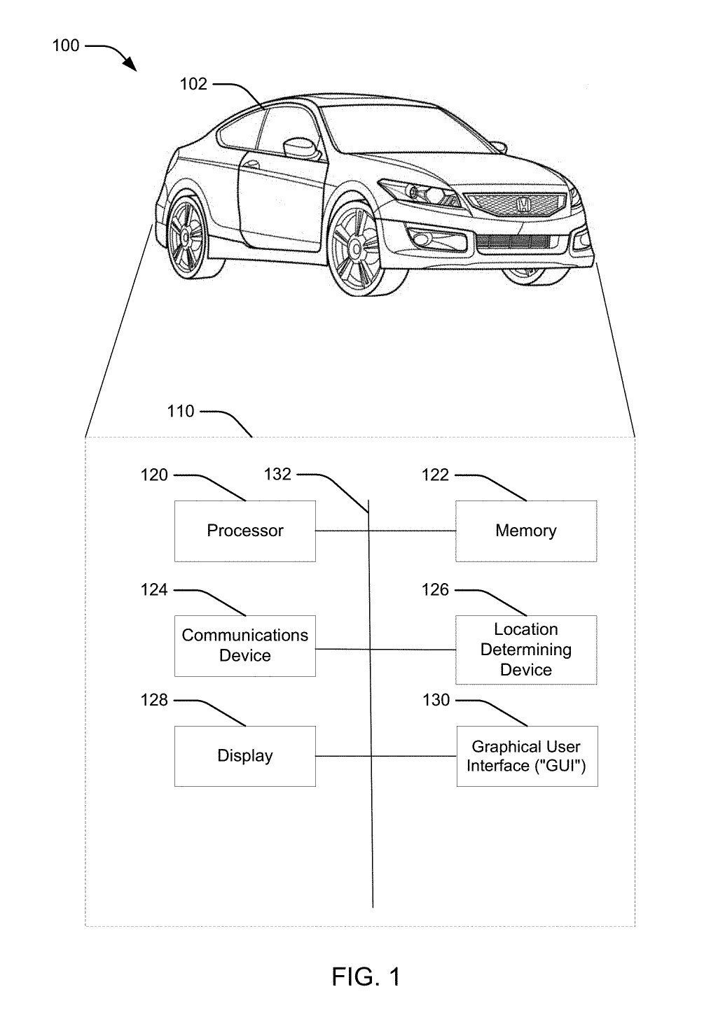

FIG. 1 shows a schematic view of an example operating environment 100 of a layout adjustment system 110 and example methods according to aspects described herein. Operating environment 100 can include a vehicle 102, within which the layout adjustment system 110 can at least partially reside and/or be implemented. Components of the layout adjustment system 110, as well as the components of other systems, hardware architectures and software architectures discussed herein, can be combined, omitted or organized into different architectures for various aspects of the disclosure. However, the example aspects and configurations discussed herein focus on the operating environment 100 as illustrated in FIG. 1, with corresponding system components and related methods.

The layout adjustment system 110 can include or be operably coupled with (or executed by) one or more processors 120 and one or more memories 122 that communicate to effectuate certain functions or actions, as described herein. For instance, the layout adjustment system 110 may include a communications device 124, which may include substantially any wired or wireless device, or related modem, etc., for providing wired or wireless communications utilizing various protocols to send/receive electronic signals internally to features and systems within the vehicle 102 and/or to external devices. In an example, communications device 124 can communicate using one or more radio technologies (e.g., 3GPP radio access technologies, IEEE 802.11, Bluetooth®, etc.). The layout adjustment system 110 can additionally include or be operably coupled with a location determining device 126 for determining a location of the vehicle 102 and/or one or more location-related parameters, such as speed, acceleration, etc. For instance, location determining device 126 can include or can be operably coupled with a global positioning system (“GPS”) device (or other latitude/longitude determination device), a speedometer, an accelerometer, a gyroscope, and/or the like, to determine the location-related parameters.

Additionally, the layout adjustment system 110 can include a display (interchangeably referred to herein as a screen) 128 for displaying one or more applications related to one or more vehicle systems. For instance, display 128 can include a liquid crystal display (LCD) and/or variants thereof, plasma display, etc., and/or can be part of a touchscreen display. In some examples, one or more of the components described for the layout adjustment system 110 can be part of another system. For example, display 128 can be part of an infotainment system of the vehicle 102. Similarly, location determining device 126 can be part of a navigation system of the vehicle 102, etc. Moreover, the various components of the layout adjustment system 110 can be operably coupled to one another via one or more busses 132 to facilitate communication among the components to perform functions described herein.

Additionally, the display 128 may be configured to accept inputs from a user regarding selections or preferences of the user via a GUI 130. For example, some inputs may include preferences of the user to display the location of the vehicle on the display 128 upon initial operation. Further, the user may input a selection to prioritize the radio application upon initial operation. Additionally, the user my increase the size and/or text of the applications on the display 128.

The vehicle 102 may include an electric motor, which may be powered by rechargeable batteries (not shown) on-board the vehicle 102. The on-board batteries may be charged when the vehicle 102 is connected to a charging station. In some aspects, the layout adjustment system 110 may display to the user the location of the charging station based upon the remaining energy of the batteries. In other aspects, the layout adjustment system 110 may override the user's preferences and show on the display 128 a route to the nearest charging station.

In addition, layout adjustment system 110 can include a graphical user interface (“GUI”) 130 for interaction with the user of the vehicle. The GUI may provide access to different applications based upon the user's preferences or selections. For example, the user may want to view the climate control application on the display, and thus may select the climate control application via the GUI 130. Additionally, for instance, the user may wish to connect a mobile device to the vehicle, and therefore may select the telephone application via the GUI 130. Further, GUI 130 may present information/data to the user in addition to the applications, e.g., current temperature outside the vehicle, current temperature at different locations, current time, the specific user's profile, and distance to recharge, among other information. The GUI 130 may also interface with other elements of the vehicle, e.g., the location determining device 126, by accessing the location of the vehicle and displaying it to the user on the display 128.

Additionally, the layout adjustment system 110 may determine the location, placement, orientation, size, or the like, of each application to be displayed on the display 128. For example, if a single application is to be displayed by the display 128, the layout adjustment system 110 may place the application to cover a majority of the area of the GUI 130, and be at a center orientation relative to the GUI 130. For example, the application may cover most of the area of the GUI 130, leaving room for essential information and controls to be displayed to the user. In some aspects, the application may cover the entire area of the GUI 130. In addition, if two applications are selected by the user via the GUI 130, the layout adjustment system may overlay the second application over a portion of the first application, and reorient the first application to ensure that the first application is centered in the remaining portion of the GUI 130 visible to the user. Additionally, the user may adjust the placement of the applications by interacting with the GUI 130. The layout adjustment process will be discussed in detail below.

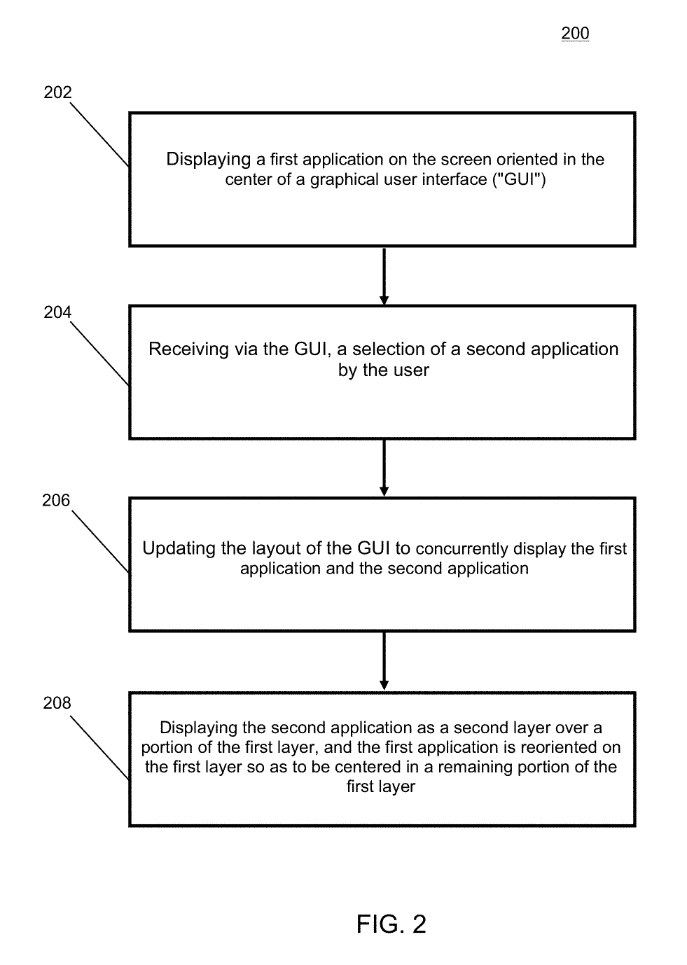

Referring now to FIG. 2, which is described in conjunction with the example operating environment 100 of FIG. 1, therein shown is an example method 200 for adjusting the layout of applications on a GUI. In block 202, the method 200 can include displaying an application on the display 128. The application may be displayed based upon a selection by the user or based upon predefined parameters or preferences. For instance, upon initialization of the display, the navigation application may be displayed to the user as set by the manufacturer or the user. Additionally, for instance, the user may select the first application to be displayed via the GUI 130. Further, the first application displayed may be orientated in the center of the GUI 130 and placed to cover the majority of the area of the GUI.

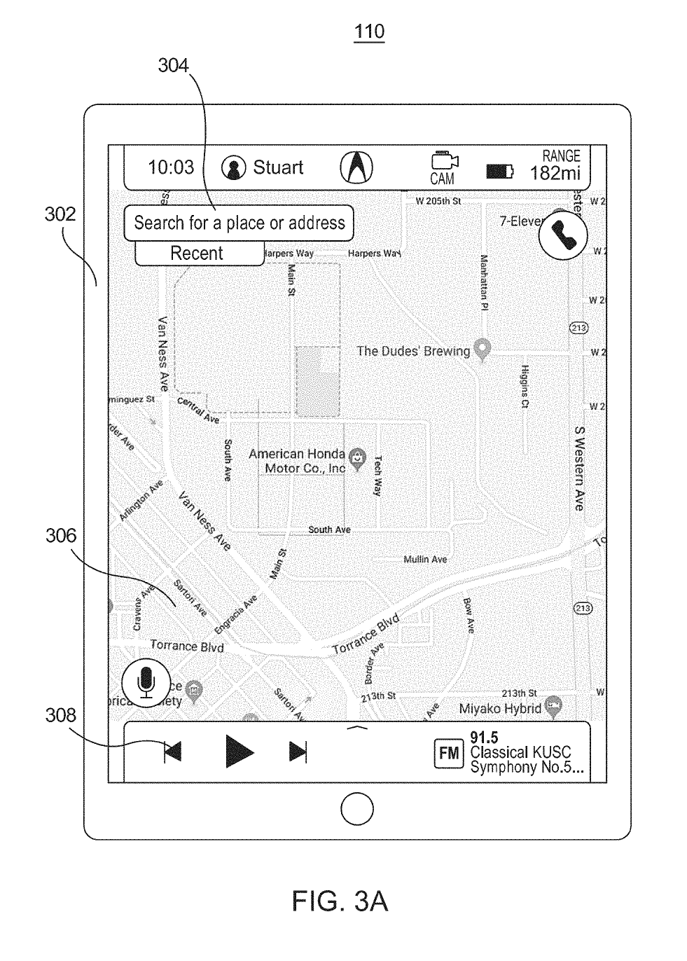

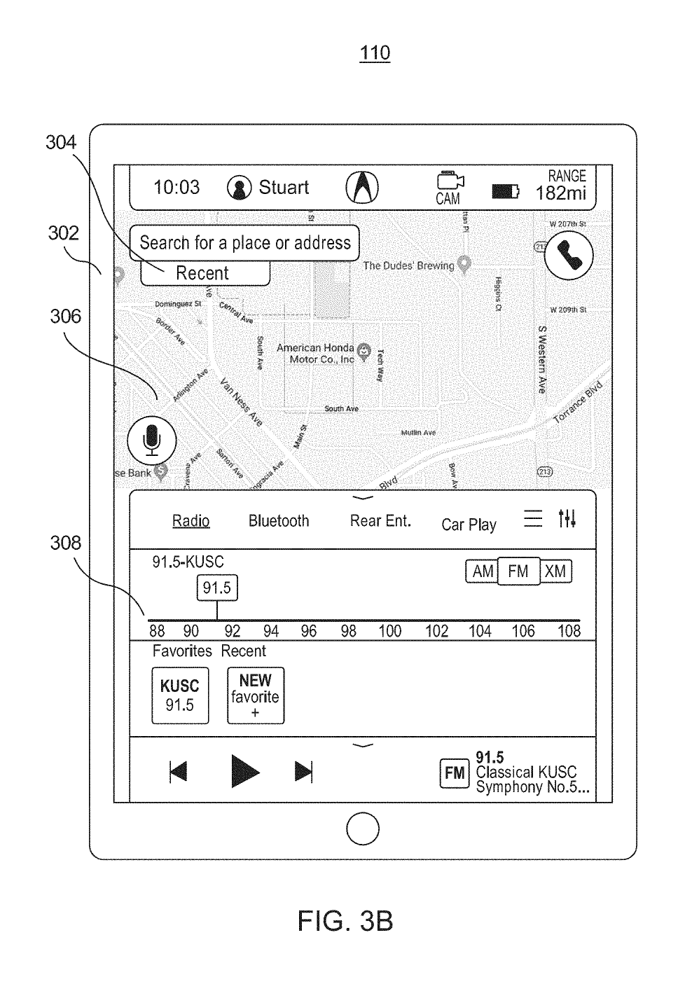

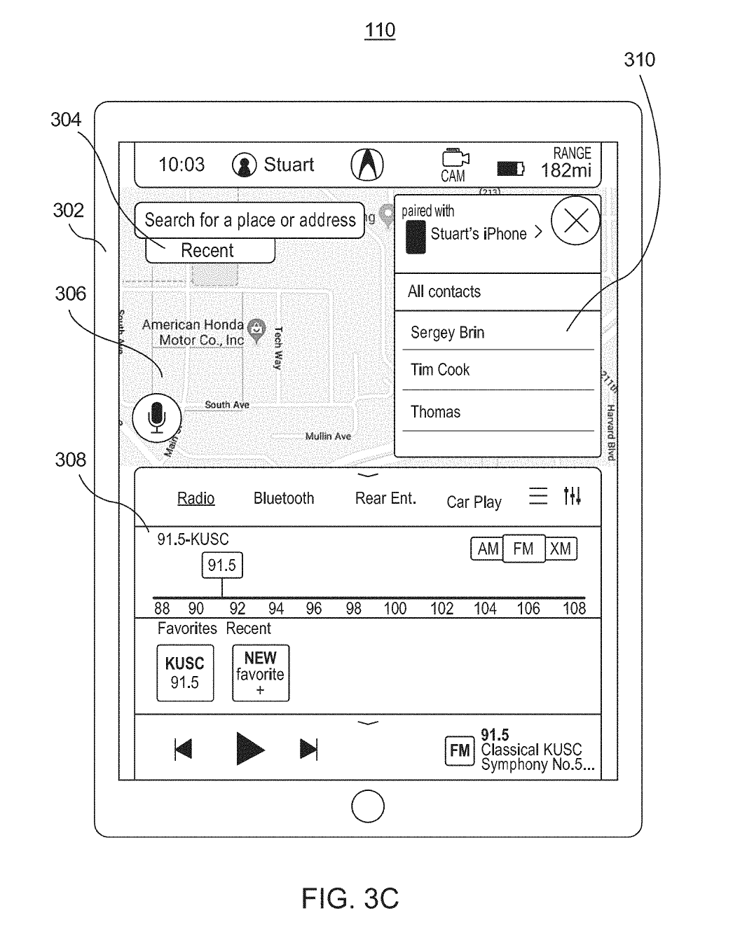

The first application may be considered the first layer on the GUI 130, as other applications and user information may be placed on top to cover the first layer. The first layer, for instance, may be covered by other information or applications in its entirety, or only a portion may be covered. For example, although the first layer may be covered in its entirety, the first layer may still be shown on the display but not visible to the user. For example, the first layer may be present on the GUI 130 regardless of the number of additional applications are also present on the GUI. This aspect will be discussed below with reference to FIG. 3(a)-(c).

In block 204, the user may select a second application to be displayed via the GUI. The second application may by the same or a different application than the first application. In block 206, the GUI 130 is updated on the screen to display both the first application and the second application. As explained above, for instance, the first application may be considered a first layer and the second application may be considered a second layer. The first layer may or may not be covered in its entity by the second layer. Each additional application selected by the user via the GUI may be considered a separate layer. For example, a third application selected by the user may be considered a third layer, and a fourth application selected by the user may be considered the fourth layer, etc. The second, third, fourth, etc., layers may, for instance, not cover each other, but may cover the first layer only.

When the second or additional applications are selected, the GUI 130 on the screen may be updated to display the first application and the second or additional applications concurrently. For example, when the third application is selected, the GUI on the screen may be updated to display the first application, the second application, and the third application concurrently. Also as an example, the additional applications may also be displayed based on at least a default size, location, orientation, and the like, where the default is based on either a selection by the user or a predetermined setting. The size, location, orientation, and the like, may also be adjusted based upon a selection by the user after being displayed on the screen.

In block 208, the second application, and each additional application, may be displayed as its respective layer, as explained above, over the first layer. The first application, for instance, may be reoriented to be centered in the remaining, if any, portion of the GUI 130 visible to the user after being covered by the additional layers. The additional applications may be displayed as centered orientation based upon the size and location of each displayed application. For example, if each additional application is displayed as a 4 inch by 4 inch box at a location near a corner of a 15 inch by 15 inch display, each application may be centered within their respective 4 inch by 4 inch box. Further, for instance, the first application may be orientated at a center location within the 15 inch by 15 inch display, as this portion of the GUI 130 is the largest remaining area visible to the user on the display. This aspect will be discussed below with reference to FIG. 3(a)-(c).

In another aspect of the present disclosure, if a navigation application is selected as the first application, the location and/or direction of the vehicle may be considered the center of the GUI 130. For example, as explained above, the location of the vehicle may be placed at the center of the 15 inch by 15 inch GUI, as this portion is the largest remaining area visible to the user on the display. Additionally, for instance, if a destination is selected by the user via the navigation application, the route may be resized and/or reoriented to display some or all of the route to the user, based upon the remaining area of the GUI 130 visible to the user on the display.

Referring now to FIG. 3A, therein illustrated is an example layout adjustment system 110 for use in accordance with an aspect of the present disclosure. In one aspect, a GUI 304 is presented on display 302. The layout adjustment system 110, for example, presents via the GUI 304, a first application 306 to a user. Additionally, for example, the layout adjustment system 110 presents via the GUI 304, a second application 308 to the user. Further, for example, the first application may be presented as first layer and the second application may be presented as a second layer, as explained above. As shown in FIG. 3A, for example, the second layer may cover a lower portion of the first layer. The first layer, for example, may be oriented in the center of the remaining visible area of the GUI 304.

Referring now to FIG. 3B, therein illustrated is an example layout adjustment system 110 for use in accordance with an aspect of the present disclosure. In one aspect, a GUI 304 is presented on display 302. The layout adjustment system 110, for example, presents via the GUI 304, a first application 306 to a user. Additionally, for example, the layout adjustment system 110 presents via the GUI 304, a second application 308 to the user. The second application 308 may be selected by the user via the GUI 304 on the display 302. Further, for example, the first application may be presented as first layer and the second application may be presented as a second layer, as explained above. As shown in FIG. 3B, for example, the second layer may be further selected by the user and may cover a larger lower portion of the first layer, as compared to FIG. 3A. The first layer, for example, may be reoriented in the center of the remaining visible area of the GUI 304 as compared to FIG. 3A.

Referring now to FIG. 3C, therein illustrated is an example layout adjustment system 110 for use in accordance with an aspect of the present disclosure. In one aspect, GUI 304 is shown on display 302. The layout adjustment system 110, for example, presents via the GUI 304, a first application 306 to a user. Additionally, for example, the layout adjustment system 110 presents via the GUI 304, a second application 308 and a third application 310 to a user. The second and third applications 308, 310 may be selected by the user via the GUI 304 on the display 302. Further, for example, the first application may be presented as first layer, the second application may be presented as a second layer and the third application may be presented as a third layer, as explained above. As shown in FIG. 3C, the second layer may cover a larger lower portion of the first layer, and the third layer may cover a portion on the upper right side of the first layer. The first layer, in this example, may be reoriented in the center of the remaining visible area of the GUI 304, as compared to FIGS. 3A and 3B. Additional applications may be implemented in the same fashion, as described above.

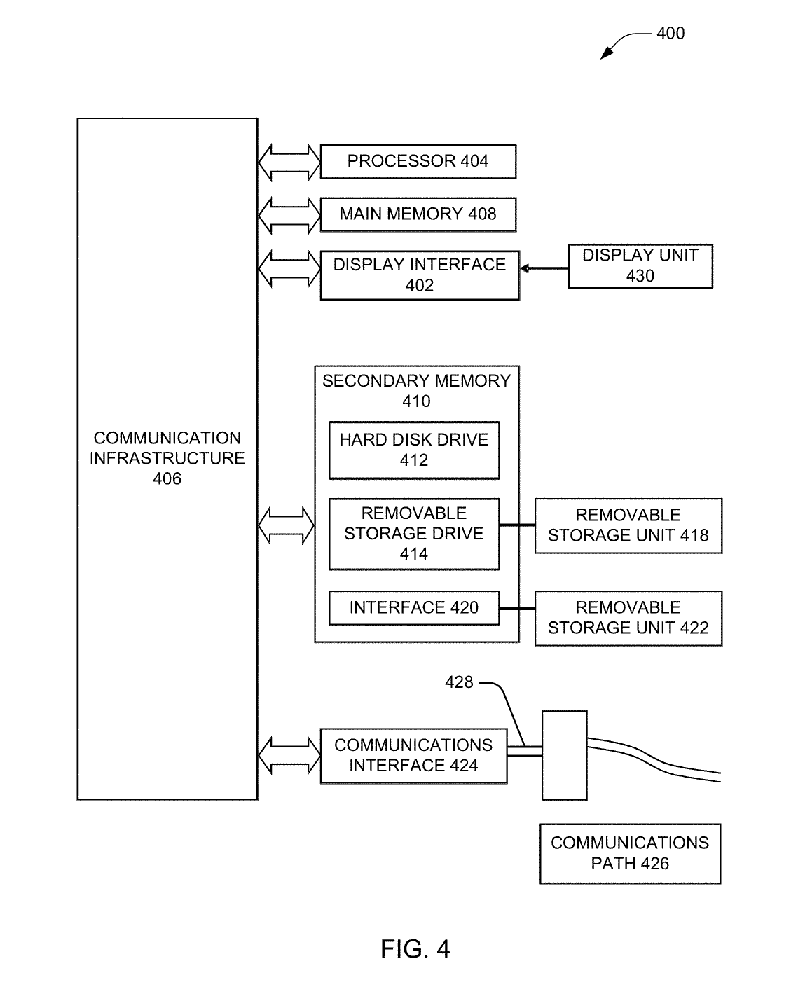

Aspects of the present disclosure can be implemented using hardware, software, or a combination thereof and can be implemented in one or more computer systems or other processing systems. In one aspect, the disclosure is directed toward one or more computer systems capable of carrying out the functionality described herein. An example of such a computer system 400 is shown in FIG. 4.

FIG. 4 presents an example system diagram of various hardware components and other features, for use in accordance with an aspect of the present disclosure. Aspects of the present disclosure can be implemented using hardware, software, or a combination thereof and can be implemented in one or more computer systems or other processing systems. In one example variation, aspects described herein can be directed toward one or more computer systems capable of carrying out the functionality described herein. An example of such a computer system 400 is shown in FIG. 4.

Computer system 400 includes one or more processors, such as processor 404. The processor 404 is connected to a communication infrastructure 406 (e.g., a communications bus, cross-over bar, or network). In one example, processor 120 can include processor 404. Various software aspects are described in terms of this example computer system. After reading this description, it will become apparent to a person skilled in the relevant art(s) how to implement aspects described herein using other computer systems and/or architectures.

Computer system 400 can include a display interface 402 that forwards graphics, text, and other data from the communication infrastructure 406 (or from a frame buffer not shown) for display on a display unit 430. Display unit 430 can include display 128, in one example. Computer system 400 also includes a main memory 408, e.g., random access memory (RAM), and can also include a secondary memory 410. The secondary memory 410 can include, e.g., a hard disk drive 412 and/or a removable storage drive 414, representing a floppy disk drive, a magnetic tape drive, an optical disk drive, etc. The removable storage drive 414 reads from and/or writes to a removable storage unit 418 in a well-known manner. Removable storage unit 418, represents a floppy disk, magnetic tape, optical disk, etc., which is read by and written to removable storage drive 414. As will be appreciated, the removable storage unit 418 includes a computer usable storage medium having stored therein computer software and/or data.

In alternative aspects, secondary memory 410 can include other similar devices for allowing computer programs or other instructions to be loaded into computer system 400. Such devices can include, e.g., a removable storage unit 422 and an interface 420. Examples of such can include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400. In an example, memory 122 can include one or more of main memory 408, secondary memory 410, removable storage drive 414, removable storage unit 418, removable storage unit 422, etc.

Computer system 400 can also include a communications interface 424. Communications interface 424 allows software and data to be transferred between computer system 400 and external devices. Examples of communications interface 424 can include a modem, a network interface (such as an Ethernet card), a communications port, a Personal Computer Memory Card International Association (PCMCIA) slot and card, etc. Software and data transferred via communications interface 424 are in the form of signals 428, which can be electronic, electromagnetic, optical or other signals capable of being received by communications interface 424. These signals 428 are provided to communications interface 424 via a communications path (e.g., channel) 426. This path 426 carries signals 428 and can be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals 428. These computer program products provide software to the computer system 400. Aspects described herein can be directed to such computer program products. Communications device 124 can include communications interface 424.

Computer programs (also referred to as computer control logic) are stored in main memory 408 and/or secondary memory 410. Computer programs can also be received via communications interface 424. Such computer programs, when executed, enable the computer system 400 to perform various features in accordance with aspects described herein. In particular, the computer programs, when executed, enable the processor 404 to perform such features. Accordingly, such computer programs represent controllers of the computer system 400. Computer programs can include layout adjustment system 110.

In variations where aspects described herein are implemented using software, the software can be stored in a computer program product and loaded into computer system 400 using removable storage drive 414, hard disk drive 412, or communications interface 420. The control logic (software), when executed by the processor 404, causes the processor 404 to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s).

In yet another example variation, aspects described herein are implemented using a combination of both hardware and software.

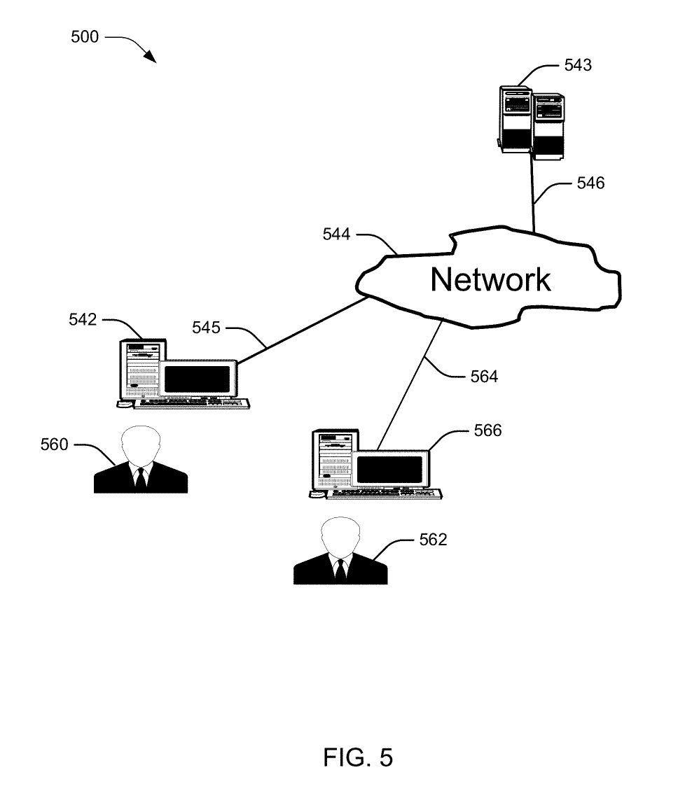

FIG. 5 is a block diagram of various example system components. FIG. 5 shows a communication system 500 including one or more accessors 560, 562 (also referred to interchangeably herein as one or more “users”) and one or more terminals 542, 566. Terminals 542, 566 can include vehicle 102 or a related system (e.g., layout adjustment system 110, processor 120, communications device 124, etc.), and/or the like. In one aspect, data for use in accordance with aspects described herein may be input and/or accessed by accessors 560, 562 via terminals 542, 566, such as personal computers (PCs), minicomputers, mainframe computers, microcomputers, telephonic devices, or wireless devices, such as personal digital assistants (“PDAs”) or a hand-held wireless devices coupled to a server 543, such as a PC, minicomputer, mainframe computer, microcomputer, or other device having a processor and a repository for data and/or connection to a repository for data, via, a network 544 for instance, such as the Internet or an intranet, and couplings 545, 546, 564. The couplings 545, 546, 564 may include wired, wireless, or fiberoptic links. In another example variation, the method and system in accordance with aspects described herein operate in a stand-alone environment, such as on a single terminal.

The aspects discussed herein can also be described and implemented in the context of computer-readable storage medium storing computer-executable instructions. Computer-readable storage media includes computer storage media and communication media, and may be, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data.

It will be appreciated that various implementations of the above-disclosed and other features and functions, or alternatives or varieties thereof, can be desirably combined into many other different systems or applications. Also that various presently unforeseen or unanticipated alternatives, modifications, variations, or improvements therein can be subsequently made by those skilled in the art which are also intended to be encompassed by the following claims.

1. A method for adjusting a layout of a graphical user interface (“GUI”) on a screen comprising:
displaying a first application on the screen oriented in the center of the GUI as a first layer;
receiving via the GUI, a selection of a second application by the user; and
updating the layout of the GUI to concurrently display the first application and the second application;
wherein the second application is displayed as a second layer over a portion of the first layer, and the first application is reoriented on the first layer so as to be centered in a largest remaining portion of the first layer; and
wherein the first and second applications are stored in a memory.

2. The method of claim 1, wherein the first application is a navigational application.

3. The method of claim 2, wherein when the navigation application is reoriented on the first layer, a location of the user is displayed as the center location.

4. The method of claim 3, wherein when a destination on the navigation application is selected, the first application is reoriented on the first layer to display a portion of a route to the user.

5. The method of claim 1, wherein the first layer is visible as background to the second layer.

6. The method of claim 1, further comprising:
receiving via the GUI, a second selection of a third application of the user; and
updating the layout of the GUI to concurrently display the first application, the second application and the third application;
wherein the third application is displayed as a third layer over a portion of the first layer, and the first application is reoriented on the first layer so as to be centered in a remaining portion of the first layer.

7. The method of claim 6, wherein the third layer is displayed over a portion of the first layer different than the second layer.

8. The method of claim 7, wherein the first layer is visible as background to the third layer.

9. A system comprising:
a memory;
a processor coupled to the memory and configured to:
display a first application on a screen oriented in the center of a graphical user interface (“GUI”) as a first layer;
receive via the GUI, a selection of a second application by a user; and
update a layout of the GUI to concurrently display the first application and the second application;
wherein the second application is displayed as a second layer over a portion of the first layer, and the first application is reoriented on the first layer so as to be centered in a largest remaining portion of the first layer; and
wherein the first and second applications are stored in the memory.

10. The system of claim 9, wherein the first application is a navigational application.

11. The system of claim 10, wherein when the navigation application is reoriented on the first layer, a location of the user is displayed as the center location.

12. The system of claim 11, wherein when a destination on the navigation application is selected, the first application is reoriented on the first layer to display a portion of a route to the user.

13. The system of claim 9, wherein the first layer is visible is background to the second layer.

14. The system of claim 9, wherein the processor is further configured to:
receive via the GUI, a second selection of a third application of the user; and
update the layout of the GUI to concurrently display the first application, the second application and the third application;
wherein the third application is displayed as a third layer over a portion of the first layer, and the first application is reoriented on the first layer so as to be centered in a remaining portion of the first layer.

15. The system of claim 14, wherein the third layer is displayed over a portion of the first layer different than the second layer.

16. The system of claim 15, wherein the first layer is visible as background to the third layer.

17. A non-transitory computer-readable storage medium containing executable computer program code, the code comprising instructions configured to cause a processor to:
display a first application on a screen oriented in the center of a graphical user interface (“GUI”) as a first layer;
receive via the GUI, a selection of a second application by a user; and
update a layout of the GUI to concurrently display the first application and the second application;
wherein the second application is displayed as a second layer over a portion of the first layer, and the first application is reoriented on the first layer so as to be centered in a largest remaining portion of the first layer.

18. The non-transitory computer-readable storage medium of claim 17, wherein the first application is a navigational application, and when the navigation application is reoriented on the first layer, a location of the user is displayed as the center location.

19. The non-transitory computer-readable storage medium of claim 18, wherein when a destination on the navigation application is selected, the first application is reoriented on the first layer to display a portion of a route to the user.

20. The non-transitory computer-readable storage medium of claim 17, wherein the processor is further configured to:
receive via the GUI, a second selection of a third application of the user; and
update the layout of the GUI to concurrently display the first application, the second application and the third application;
wherein the third application third layer over a portion of the first layer, and the first application is the first layer so as to be centered in a remaining portion of the first layer.
